(19) United States
(12) Patent Application Publication
(10) Pub. No.: US 2017/0242693 A1
(43) Pub. Date: Aug. 24, 2017

(54) SAFETY MONITORING DEVICE, NETWORK SYSTEM AND SAFETY MONITORING METHOD

(71) Applicant: Renesas Electronics Corporation, Tokyo (JP)

(72) Inventor: Ryohei IZAKI, Tokyo (JP)

(21) Appl. No.: 15/372,222

(22) Filed: Dec. 7, 2016

(30) Foreign Application Priority Data
Feb. 22, 2016 (JP) 2016-030596

(51) Int. Cl. G06F 9/22; G06F 9/48

(52) U.S. Cl. CPC G06F 9/226; G06F 9/4881; G06F 9/485

(57) ABSTRACT

A safety I/O module (10) disposed between a network (NW) and a target device (20) is provided. The safety I/O module (10) includes MCUs (121, 122). Further, the each of the MCUs (121, 122) includes a CPU (123) and an RTOS accelerator (124) configured to perform a process for switching a task executed by the CPU (123) and a process for starting the task.

### CROSS-REFERENCE TO RELATED APPLICATIONS

This application is based upon and claims the benefit of priority from Japanese patent application No. 2016-030596, filed on Feb. 22, 2016, the disclosure of which is incorporated herein in its entirety by reference.

### BACKGROUND

The present invention relates to a safety monitoring device and can be suitably used, for example, fora safety monitoring device in the field of industrial networks.

Functional safety standards are laid down by IEC (International Electrotechnical Commission) 61508 on a product category basis. Recently, it has become mandatory to conform to the IEC61508 even in the field of industrial networks.

Therefore, network systems used in the industrial network field are equipped with the below-described configuration in order to conform to the functional safety standard laid down by the IEC61508. (1) A safety I/O (Input/Output) module that monitors data received/output by a device for which functional safety should be secured (such as a sensor and an actuator) (hereinafter called a “target device”) is provided on a network. (2) Data received/output by the target device is made redundant.

It should be noted that in the safety I/O module, microcomputers are made redundant (i.e., configured as a redundant system) to handle the redundant data received/output from/to the target device. When data is received from the network in the safety I/O module, the two microcomputers perform the same process for the data and check each other's process results of (i.e., cross-check their process results). Then, when the safety of the data is verified, the data is made redundant and the redundant data are output to the target device.

Note that examples of the safety I/O module are disclosed in Non-patent Literature 1 (Rockwell Automation, Inc., “Safety Input/Output (I/O) module”, [online], [Searched on Nov. 5, 2015], the Internet <URL:http://ab.rockwellautomation.com/ja/Safety/IO>) and Non-patent Literature 2 (SHINO Junichiro, others: 2, “Information and Process Control System to Support Stabilization and Safety ‘MICREX-NX’”, [online], Fuji Electric Journal, 2014 vol. 87 No. 1, [Searched on Nov. 5, 2015], the Internet <URL:http://www.fujielectric.co.jp/about/company/gihou_2014/pd f/87-01/FEJ-87-01-0038-2014.pdf>). The redundant microcomputers are disclosed in, for example, the aforementioned Non-patent Literature 2 and Non-patent Literature 3 (Renesas Electronics Corporation, “Functional Safety Solution for Industrial Automation”, [online], [Searched on Nov. 5, 2015], the Internet <URL:http://japan.renesas.com/applications/industrial_equipment/common_{—}technologies_for_industry/functional_safety_solution_for_industrial_automation/index.jsp>). The cross-checking is disclosed in, for example, Japanese Unexamined Patent Application Publication No. 2006-178730.

### SUMMARY

In the industrial network field, an actuator, for example, needs to perform an operation without delay while reflecting a result detected by a sensor in the operation. Like in this example, data communication between target devices requires a real-time response capability.

However, there has been a problem that since the safety I/O module is implemented by having the microcomputer perform the above-described operation by using software, its processing speed is low and the real-time response property is poor.

Other objects and novel features will be more apparent from the following description in the specification and the accompanying drawings.

According to one embodiment, a safety monitoring device includes first and second microcomputers. Further, each of the first and second microcomputers includes a CPU and a first hardware device configured to perform a process for switching a task executed by the CPU and a process for starting the task.

According to the embodiment, it is possible to contribute to the solution of the above-described problem.

### BRIEF DESCRIPTION OF THE DRAWINGS

The above and other aspects, advantages and features will be more apparent from the following description of certain embodiments taken in conjunction with the accompanying drawings, in which:

FIG. 1 shows a configuration example of a network system according to a first embodiment;

FIG. 2 is a block diagram showing a configuration example of a safety I/O module 10A (10B) according to the first embodiment;

FIG. 3A is a block diagram showing a configuration example of an MCU 121 (122) according to the first embodiment;

FIG. 3B is a block diagram showing a configuration example of an RTOS accelerator 124 according to the first embodiment;

FIG. 3C is a block diagram showing a configuration example of an Ethernet (Registered Trademark) accelerator 125 according to the first embodiment;

FIG. 4 shows an example of a frame structure of an Ethernet frame according to the first embodiment;

FIG. 5 shows an effect of an RTOS accelerator 124 and an Ethernet accelerator 125 according to the first embodiment;

FIG. 6 is a flow diagram showing an operation example of MCUs 121 and 122 according to the first embodiment;

FIG. 7 shows an effect of an RTOS accelerator 124 according to the first embodiment;

FIG. 8 is a flow diagram showing details of an operation example of steps S12 and S22 in FIG. 6 performed by MCUs 121 and 122 according to the first embodiment; and

FIG. 9 is a block diagram showing a configuration example of a safety I/O module 10A (10B) according to a second embodiment.

### DETAILED DESCRIPTION

Embodiments are explained hereinafter in detail with reference to the drawings. Note that, for clarifying the explanation, the following descriptions and the drawings may be partially omitted and simplified as appropriate. Further, the same symbols are assigned to the same components throughout the drawings and duplicated explanations are omitted as required.

### (1) First Embodiment

### <Configuration of Network System>

Firstly, a configuration of a network system according to a first embodiment is explained with reference to FIG. 1. As shown in FIG. 1, the network system according to the first embodiment is used for transmitting data representing a detection result detected in a sensor 20A to an actuator 20B through an Ethernet NW in the field of industrial networks. In the network system according to the first embodiment, the sensor 20A and the actuator 20B are devices for which functional safety should be secured (hereinafter called “target devices”).

Further, the network system according to the first embodiment includes, in addition to the above-described sensor 20A and the actuator 20B, safety I/O modules 10A and 10B, a safety PLC (Programmable Logic Controller) 30, and a PLC 40. The Ethernet NW is an example of a network and the safety I/O modules 10A and 10B are examples of safety monitoring devices. Further, in the following explanation, when it is unnecessary to specify whether the safety I/O module 10A or the safety I/O module 10B is concerned, a “safety I/O module 10” is simply referred to. Further, when it is unnecessary to specify whether the sensor 20A or the actuator 20B is concerned, a “target device 20” is simply referred to.

The PLC 40 is a control device that performs the overall control of the network system. The safety PLC 30 is a safety control device that performs control related to the functional safety of the target devices 20 (the sensor 20A and the actuator 20B in FIG. 1) in the network system.

The sensor 20A transmits data representing a detection result detected by the sensor 20A itself to the actuator 20B through the Ethernet NW. The actuator 20B receives the data representing the detection result detected by the sensor 20A from the sensor 20A through the Ethernet NW.

The safety I/O module 10A is disposed between the sensor 20A and the Ethernet NW and monitors data that is output from the sensor 20A and transmitted to the Ethernet NW. Data is made redundant between the sensor 20A and the safety I/O module 10A.

The safety I/O module 10B is disposed between the actuator 20B and the Ethernet NW and monitors data that is received from the Ethernet NW and input to the actuator 20B. Data is made redundant between the safety I/O module 10B and the actuator 20B.

### <Operation of Network System>

Next, an overview of operations of a network system according to a first embodiment is explained. When redundant data are input from the sensor 20A to the safety I/O module 10A, the safety I/O module 10A compares these data with each other by using two MCUs (Micro Control Units, also referred to as microcomputers), which are described later. Then, when it is verified that the data match each other, the safety I/O module 10A transmits the data to the Ethernet NW. The data of the sensor 20A is transmitted to the safety I/O module 10B through the safety PLC 30 on the Ethernet NW.

Upon receiving the data of the sensor 20A from the Ethernet NW, the safety I/O module 10B uses two MCUs to perform the same process and check each other's process results (i.e., cross-check their process results). Then, when the safety of the data is verified, the safety I/O module 10B makes the data redundant and outputs the redundant data to the actuator 20B.

Note that in FIG. 1, the safety I/O module 10A receives data from the target device 20 (the sensor 20A in FIG. 1) and transmits the received data to the Ethernet NW. However, it is assumed that the safety I/O module 10A also has a function of receiving data from the Ethernet NW and outputting the received data to the target device 20. Further, although the safety I/O module 10B receives data from the Ethernet NW and transmits the received data to the target device 20 (the actuator 20B in FIG. 1), it is assumed that the safety I/O module 10B also has a function of receiving data from the target device 20 and outputting the received data to the Ethernet NW.

### <Configuration of Safety I/O Module>

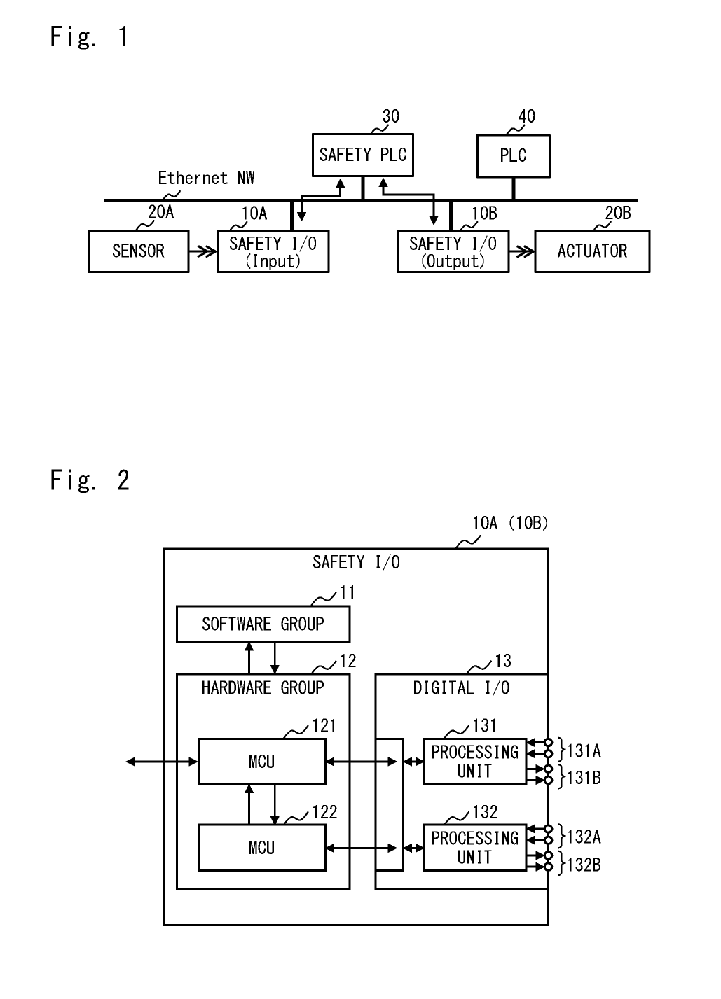

Next, a configuration of the safety I/O modules 10A and 10B according to the first embodiment is explained with reference to FIG. 2. As shown in FIG. 2, each of the safety I/O modules 10A and 10B according to the first embodiment includes a group of software programs (hereinafter also referred to as a “software group”) 11, a group of hardware components (hereinafter also referred to as a “hardware group”) 12, and a digital I/O 13.

The software group 11 includes various software programs such as a monitoring application and a self-diagnosis application (not shown).

The hardware group 12 includes two MCUs 121 and 122. The MCUs 121 and 122 are an example of the first and second microcomputers. The MCU 121 is connected to the Ethernet NW. The MCUs 121 and 122 are connected to each other by a serial connection through an external peripheral component or the like (not shown) and perform cross-communication with each other through serial communication. Note that the hardware group 12 includes, in addition to the MCUs 121 and 122, other hardware components such as a power supply circuit and a monitoring circuit (not shown).

The digital I/O 13 includes a processing unit 131, a safety input port 131A, a safety output port 131B, a processing unit 132, a safety input port 132A, and a safety output port 132B. The safety input ports 131A, 131B, 132A and 132B are connected to the target device 20.

One of the redundant data output from the target device 20 is input to the MCU 121 through the safety input port 131A and the processing unit 131, and the other of the redundant data is input to the MCU 122 through the safety input port 132A and the processing unit 132. The MCUs 121 and 122 compare each other's data. Then, when it is verified that the data match each other, the data is transmitted from the MCU 121 to the Ethernet NW.

Further, the data from the Ethernet NW is received by the MCU 121 and then delivered from the MCU 121 to the MCU 122. The MCUs 121 and 122 perform the same process for their data and check each other's process results. Then, when the safety of the data is verified, the data is output from the MCU 121 to the target device 20 through the processing unit 131 and the safety output port 131B. Further, the data is output from the MCU 122 to the target device 20 through the processing unit 132 and the safety output port 132B.

### <Configuration of MCU>

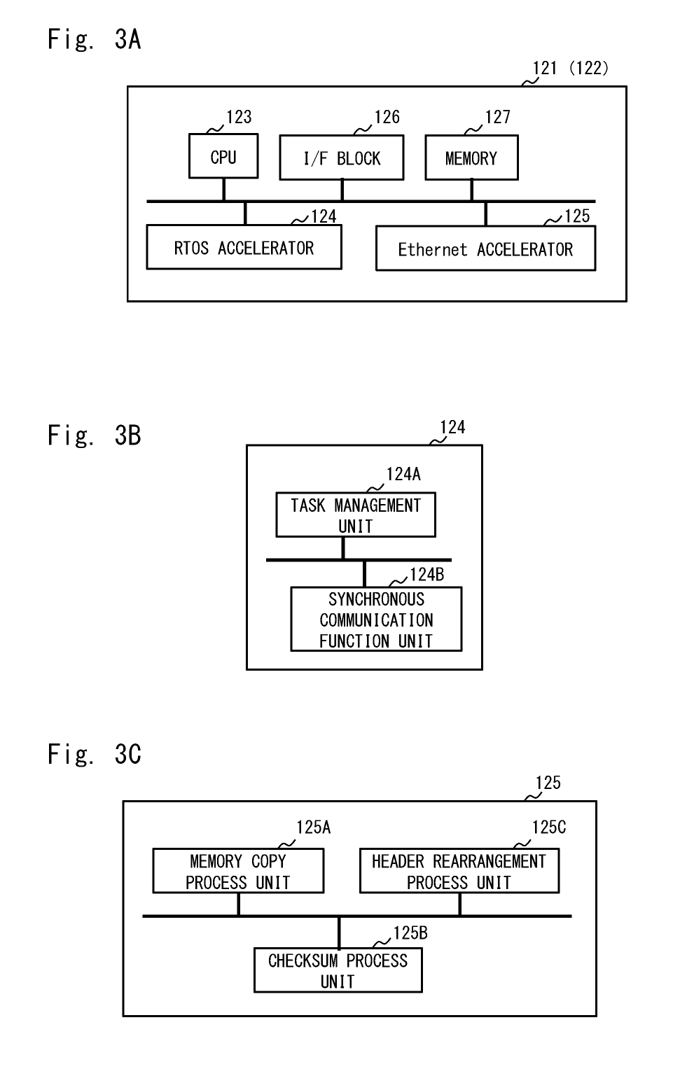

Next, a configuration of the MCUs 121 and 122 according to the first embodiment is explained with reference to FIG. 3A. As shown in FIG. 3A, each of the MCUs 121 and 122 according to the first embodiment includes a CPU (Central Processing Unit) 123, an RTOS (Real-Time Operating System) accelerator 124, an Ethernet accelerator 125, an I/F (Interface) block 126, and a memory 127. The RTOS accelerator 124 is an example of the first hardware device and the Ethernet accelerator 125 is an example of the second hardware device.

The CPU 123 performs a process related to its safety I/O module 10 by using software included in the software group 11.

The I/F block 126 includes an I/F for communication with the other hardware included in the hardware group 12, an I/F for communication with the digital IO 13, an I/F for communication with the MCU of the other channel, and various other I/Fs.

The memory 127 stores data received from the Ethernet NW, data to be transmitted to the Ethernet NW, and so on.

The RTOS accelerator 124 and the Ethernet accelerator 125 are characteristic components of the first embodiment. That is, they are formed as hardware (i.e., constructed in the form of hardware components) to perform an RTOS process and an Ethernet communication process, respectively, which have been performed by software in the related art.

Specifically, as shown in FIG. 3B, the RTOS accelerator 124 includes at least a task management unit 124A that performs a process for switching a task executed by the CPU 123 and a process for starting a (new) task, and a synchronous communication function unit 124B that performs a synchronizing process when a timer interrupt occurs or the like.

Further, as shown in FIG. 3C, the Ethernet accelerator 125 includes a memory copy process unit 125A, a checksum process unit 125B, and a header rearrangement process unit 125C that perform, as Ethernet communication processes, a memory copy process, a checksum process, and a header rearrangement process, respectively.

The memory copy process is a process for recording data received from the Ethernet NW or data to be transmitted to the Ethernet NW in the memory 127.

The checksum process is a process for detecting an error in data received from the Ethernet NW. For example, in the checksum process, a checksum of data received from the Ethernet NW is calculated and the calculated checksum is compared with a checksum that has been added to the data. Then, when these checksums are not equal to each other, it is detected (i.e., determined) that the data is erroneous.

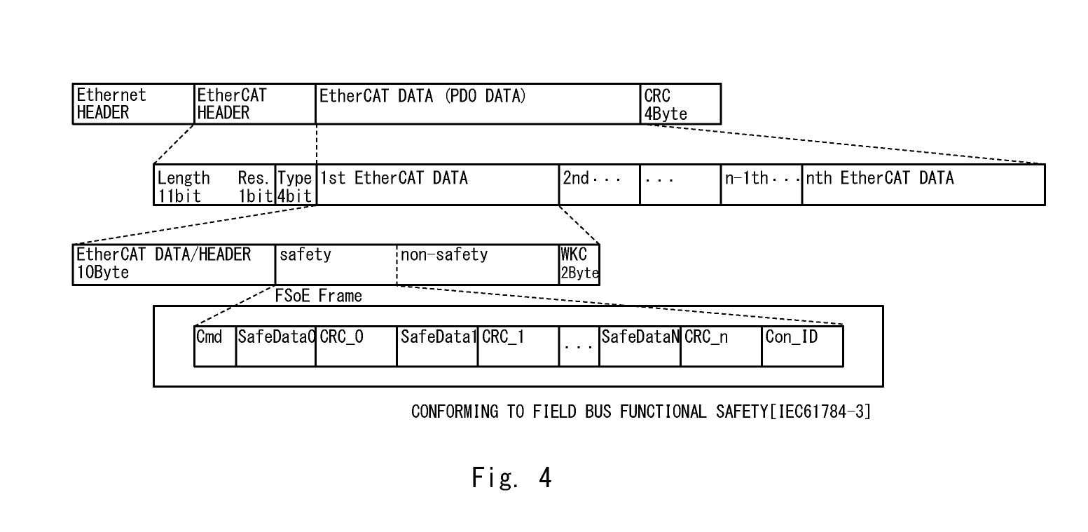

The header rearrangement process includes a process for extracting data from an Ethernet frame and a process for storing data in an Ethernet frame. Data is transmitted in the form of an Ethernet frame on the Ethernet NW. FIG. 4 shows an example of a frame structure of the Ethernet frame. Data is stored in an EtherCAT (Control Automation Technology) data (PDO (Process Data Object) data) area of the Ethernet frame. Further, the EtherCAT data area is divided into areas for respective data and the area for each data includes a safety area and a non-safety area. Data addressed to a target device 20 for which functional safety should be ensured is stored in the safety area and data addressed to a non-target device (not shown) other than the target device 20 is stored in the non-safety area. Note that in FIG. 4, the EtherCAT (Control Automation Technology) data is shown as an example of Ethernet frame formats. However, the frame format is not limited to this example.

In the first embodiment, both of the safety I/O modules 10A and 10B are disposed between the Ethernet NW and the target device 20. Therefore, when an Ethernet frame is received from the Ethernet NW, a process for extracting data from the safety area of that Ethernet frame will be performed. Further, when an Ethernet frame is transmitted to the Ethernet NW, a process for storing data in the safety area of that Ethernet frame will be performed.

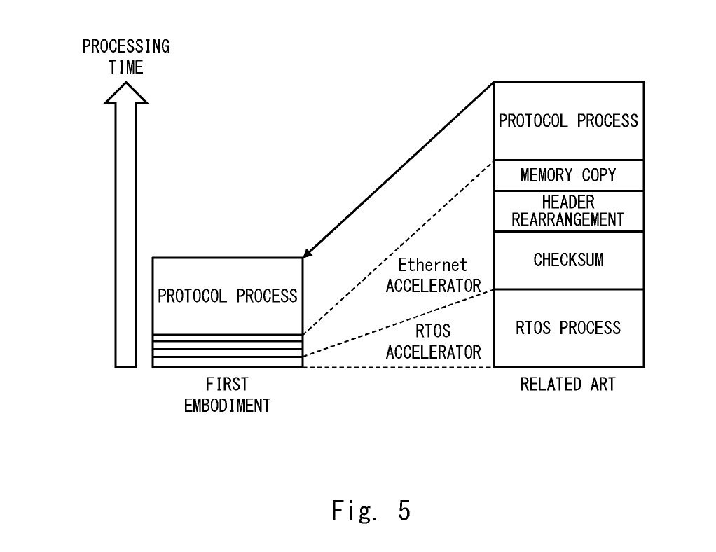

In the first embodiment, the RTOS accelerator 124, which is formed as hardware, performs the RTOS process and the Ethernet accelerator 125, which is also formed as hardware, performs the memory copy process, the checksum process, and the header rearrangement process. Therefore, as shown in FIG. 5, compared to the related art in which the RTOS process, the memory copy process, the checksum process, and the header rearrangement process are performed by software, the processing time for these processes is reduced. Note that in FIG. 5, the protocol process is a communication establishment process in conformity with the protocol or the like and performed by the CPU 123 as in the case of the related art.

### <Operation of MCU>

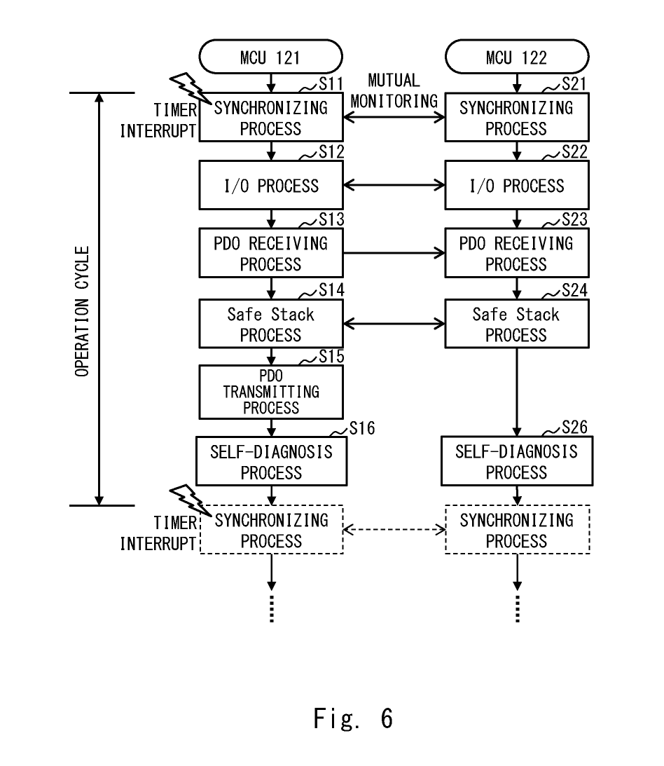

Next, an operation of the MCUs 121 and 122 according to the first embodiment is explained with reference to FIG. 6. As shown in FIG. 6, the MCUs 121 and 122 repeat cyclic operations. As explained below, each of the MCUs 121 and 122 performs an input/output process between the MCU and the target device 20 and a transmitting/receiving process between the MCU and the Ethernet NW in one operation cycle.

When a timer interrupt occurs, the MCUs 121 and 122 start synchronizing processes by using their respective RTOS accelerators 124 (steps S11 and S21). The synchronizing processes of the MCUs 121 and 122 are the same as each other and therefore the synchronizing process performed by the MCU 121 is explained as an example. In the synchronizing process, the CPU 123 of the MCU 121 checks whether or not the process of the previous operation cycle of its own MCU 121 has been finished. When the process has not been finished yet, the CPU 123 determines that its own MCU 121 is out of order and hence changes the state of the MCU 121 to a Critical Fault state which is a state in which a failure has been detected. Further, in the synchronizing process, the CPU 123 of the MCU 121 waits for cross-communication from the other MCU 122. If the next timer interrupt occurs while the CPU 123 is waiting for the cross-communication, the CPU 123 changes the state of the MCU 121 to the Critical Fault state. That is, if synchronization is not obtained by the cross-communication within one operation cycle, the CPU 123 of the MCU 121 determines that the other MCU 122 is out of order.

Next, in parallel with the checking of mutual monitoring results (or cross-monitoring results) in the MCUs 121 and 122 performed by the MCU 121, the MCUs 121 and 122 change the tasks and start I/O processes by using their respective RTOS accelerators 124 (steps S12 and S22). The I/O processes of the MCUs 121 and 122 are the same as each other and therefore the I/O process performed by the MCU 121 is explained as an example. In the I/O process, the CPU 123 of the MCU 121 receives data from the target device 20 and checks whether the received data is identical to data of the other MCU 122. Further, in the I/O process, the CPU 123 of the MCU 121 outputs the data, which is received from the Ethernet NW and whose safety is verified, to the target device 20. Note that a specific flow of the I/O process will be described later.

Note that similarly to the steps S12 and S22, the subsequent processes are also performed in parallel with the checking of mutual monitoring results in the MCUs 121 and 122 performed by the MCU 121.

Next, the MCUs 121 and 122 change the tasks and start PDO (Process Data Object) receiving processes by using their respective RTOS accelerators 124 (steps S13 and S23). In the PDO receiving process, the Ethernet accelerator 125 of the MCU 121 performs a process for receiving an Ethernet frame from the Ethernet NW, a process for extracting data from the Ethernet frame (a header rearrangement process), a process for recording that data in the memory 127 (a memory copy process), and a process for detecting an error in that data (a checksum process). Further, the CPU 123 of the MCU 121 performs a process for delivering the data extracted from the Ethernet frame to the other MCU 122. In the PDO receiving process, the CPU 123 of the MCU 122 performs a process for receiving data delivered from the other MCU 121. Further, the Ethernet accelerator 125 of the MCU 122 performs a process for recording that data in the memory 127 (a memory copy process) and a process for detecting an error in that data (a checksum process).

Next, the MCUs 121 and 122 change the tasks and start Safe Stack processes by using their respective RTOS accelerators 124 (steps S14 and S24). The Safe Stack processes of the MCUs 121 and 122 are the same as each other and therefore the Safe Stack process performed by the MCU 121 is explained as an example. In the Safe Stack process, the CPU 123 of the MCU 121 performs a process for the data extracted from the Ethernet frame and checks its safety by mutually checking (or cross-checking) its process result with a process result of the other MCU 122. In the Safe Stack process, the CPU 123 of the MCU 121 performs, in addition to the above-described processes, a status notification process, a state management process, a connection management process, a CRC (Cyclic Redundancy Check) process, and so on.

Next, the MCU 121 changes the task and starts a PDO transmitting process by using the RTOS accelerator 124 (step S15). In the PDO transmitting process, the Ethernet accelerator 125 of the MCU 121 performs a process for recording data to be transmitted to the Ethernet NW in the memory 127 (a memory copy process), a process for storing that data in an Ethernet frame (a header rearrangement process), and a process for transmitting the Ethernet frame to the Ethernet NW.

Next, the MCUs 121 and 122 change the tasks and start self-diagnosis processes by using their respective RTOS accelerators 124 (steps S16 and S26). The self-diagnosis processes of the MCUs 121 and 122 are the same as each other and therefore the self-diagnosis process performed by the MCU 121 is explained as an example. In the self-diagnosis process, the CPU 123 of the MCU 121 diagnoses (i.e., determines) whether its own MCU 121 is properly operating.

By the above-described processes, the process of one operation cycle is finished. The above-described series of processes are repeatedly performed every time a timer interrupt occurs.

As described above, in the first embodiment, the MCUs 121 and 122 repeat the cyclic operation shown in FIG. 6. Further, the MCUs 121 and 122 perform, in one operation cycle, the task changing process and the task starting process that are inserted (i.e., performed) between each two successive steps by using the RTOS accelerator 124, which is formed as hardware.

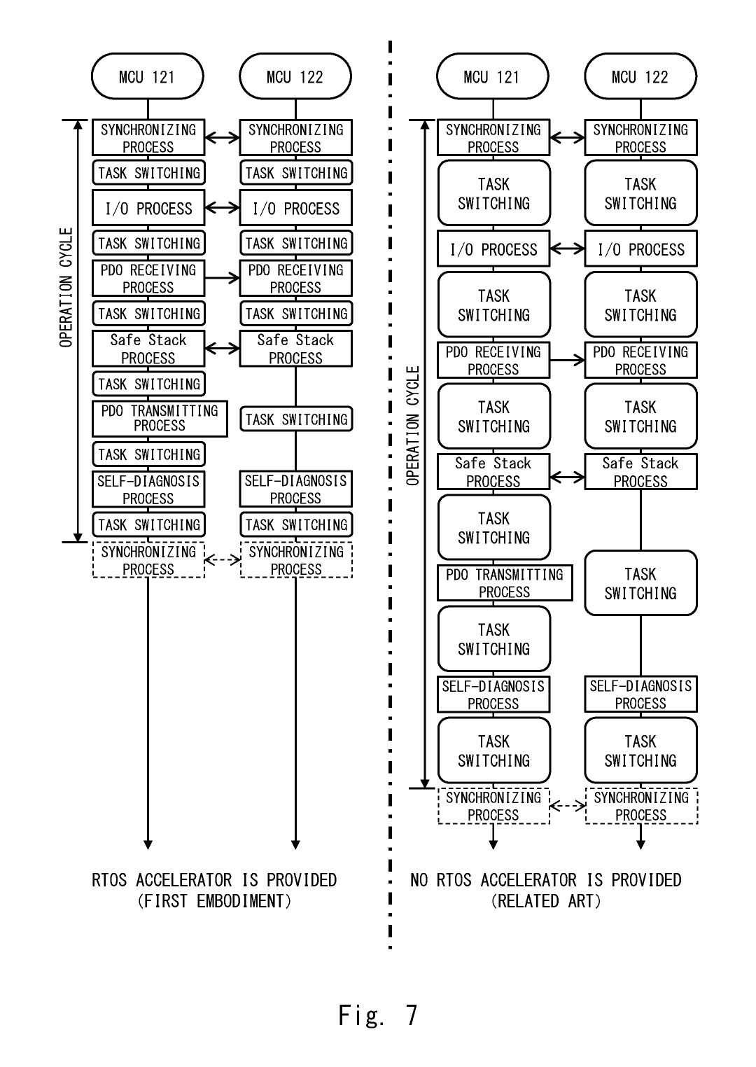

Therefore, as shown in FIG. 7, compared to the related art in which the RTOS accelerator 124 is not provided, the processing time for the task changing process and the task starting process is reduced and hence one operation cycle of cyclic operations performed by the MCUs 121 and 122 is shortened. As a result, in the MCUs 121 and 122, the period of the I/O process in which data is input/output between the MCUs 121 and 122 and the target device 20 and the period of the PDO receiving process and the PDO transmitting process in which data is transmitted/received between the MCUs 121 and 122 and the Ethernet NW can be shortened.

Note that in reality, the process in each step shown in FIG. 6 consists of a plurality of tasks and the task changing process and the task starting process in each step are also performed by the RTOS accelerator 124. Therefore, in reality, the operation cycle of the MCUs 121 and 122 is shortened more than the one shown in FIG. 7.

Further, in the first embodiment, the memory copy process, the checksum process, and the header rearrangement process, which are performed in the PDO receiving process and the PDO transmitting process in which data is transmitted/received between the MCUs 121 and 122 and the Ethernet NW, are performed by the Ethernet accelerator 125, which is formed as hardware. As a result, the processing speed of the PDO receiving process and the PDO transmitting process themselves can be increased in the MCUs 121 and 122.

### <I/O Process of MCU>

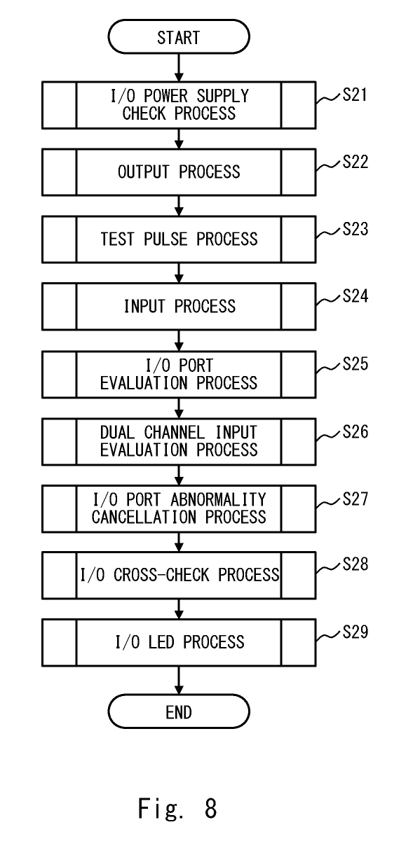

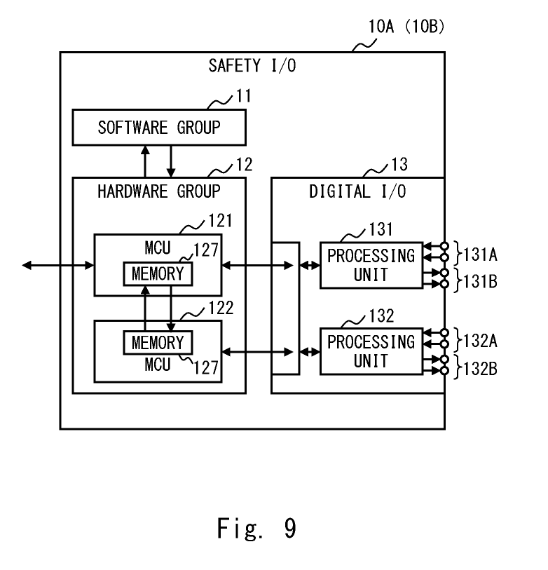

Next, the I/O processes in the steps S12 and S22 in FIG. 6 performed by the MCUs 121 and 122 according to the first embodiment are explained with reference to FIG. 8. As described above, since the I/O processes of the MCUs 121 and 122 are the same as each other, the I/O process performed by the MCU 121 is explained as an example.

As shown in FIG. 8, the MCU 121 starts an I/O power supply check process by using the RTOS accelerator 124 (step S21). In the I/O power supply check process, the CPU 123 of the MCU 121 checks a power supply state of I/O ports of its own channel in order to make the state of the I/O ports of its own channel (the safety input port 131A and the safety output port 131B) and the state of the I/O ports of the other channel (the safety input port 132A and the safety output port 132B) the same as each other.

Next, the MCU 121 changes the task and starts an output process by using the RTOS accelerator 124 (step S22). In the output process, the CPU 123 of the MCU 121 outputs data, which is received from the Ethernet NW and whose safety is verified, from the safety output port 131B to the target device 20.

Next, the MCU 121 changes the task and starts a test pulse process by using the RTOS accelerator 124 (step S23). In the test pulse process, the CPU 123 of the MCU 121 outputs a test pulse to the safety input port 131A and the safety output port 131B and checks the state of the safety input port 131A and the safety output port 131B.

Next, the MCU 121 changes the task and starts an input process by using the RTOS accelerator 124 (step S24). In the input process, the CPU 123 of the MCU 121 receives data from the target device 20 through the safety input port 131A.

Next, the MCU 121 changes the task and starts an I/O port evaluation process by using the RTOS accelerator 124 (step S25). In the I/O port evaluation process, the CPU 123 of the MCU 121 evaluates (i.e., determines) whether the safety input port 131A and the safety output port 131B are normal or abnormal based on the state of the safety input port 131A and the safety output port 131B. If there is a port that is evaluated (i.e., determined) as being abnormal among the safety input port 131A and the safety output port 131B, the status of that port is changed to an abnormal state and the port is cut off.

Next, the MCU 121 changes the task and starts a dual channel input evaluation process by using the RTOS accelerator 124 (step S26). In the dual channel input evaluation process, the CPU 123 of the MCU 121 checks whether the data received from the target device 20 is the same as the data of the other MCU 122.

Next, the MCU 121 changes the task and starts an I/O port abnormality cancellation process by using the RTOS accelerator 124 (step S27). In the I/O port abnormality cancellation process, when there is a port that is evaluated as being abnormal among the safety input port 131A and the safety output port 131B, the CPU 123 of the MCU 121 restores the status of that port from the abnormal state to a normal state.

Next, the MCU 121 changes the task and starts an I/O cross-check process by using the RTOS accelerator 124 (step S28). In the I/O cross-check process, the CPU 123 of the MCU 121 interchanges data input/output from/to the target device 20 and/or the statuses of the safety input port 131A and the safety output port 131B with those of the other MCU 122 and thereby evaluates them.

After that, the MCU 121 changes the task and starts an I/O LED process by using the RTOS accelerator 124 (step S29). In the I/O LED process, the CPU 123 of the MCU 121 performs LED-displaying (i.e., turns on/off LEDs) according to the statuses of the safety input port 131A and the safety output port 131B.

Note that in FIG. 8, the dual channel input evaluation process in the step S26 and the I/O cross-check process in the step S28 are processes that are newly introduced because data input/output by the target device 20 are made redundant in order to conform to the functional safety standard established by IEC61508.

However, in the first embodiment, the changing process and the starting process performed among a plurality of tasks included in the above-described newly introduced processes are also performed by the RTOS accelerator 124. Therefore, although new processes are introduced because of the redundancy of data, the processing time for these processes can be reduced.

### Effect of First Embodiment

As described above, in the first embodiment, the MCUs 121 and 122 perform the changing process and the starting process of the task, which is executed by the CPU 123, by using the RTOS accelerator 124, which is formed as hardware.

As a result, the MCUs 121 and 122 can shorten the period of the data input/output process between the MCUs 121 and 122 and the target device 20 and the period of the data transmitting/receiving process between the MCUs 121 and 122 and the Ethernet NW, data that is communicated between the MCUs 121 and 122 and the target device 20 through the Ethernet NW can be processed at a high speed. Therefore, the MCUs 121 and 122 can contribute to an improvement in the real-time response property.

Further, in the first embodiment, the MCUs 121 and 122 perform the memory copy process, the checksum process, and the header rearrangement process, which are performed when data is transmitted/received between the MCUs 121 and 122 and the Ethernet NW, by using the Ethernet accelerator 125, which is formed as hardware.

As a result, since the MCUs 121 and 122 can increase the speed of data transmitting/receiving process itself between the MCUs 121 and 122 and the Ethernet NW, they can contribute to the improvement in the real-time response property even further.

### (2) Second Embodiment

A configuration of the safety I/O modules 10A and 10B according to a second embodiment is explained with reference to FIG. 9.

In the first embodiment, the MCUs 121 and 122 are connected to each other by a serial connection through an external peripheral component or the like (not shown) and perform cross-communication with each other through serial communication.

In contrast to this, in the second embodiment, the memories 127 of the MCUs 121 and 122 are directly connected to each other as shown in FIG. 9. That is, the MCUs 121 and 122 share their memories 127. Further, the CPUs 123 of the MCUs 121 and 122 perform cross-communication by writing/reading data to/from the memories 127. For example, when the MCU 121 transmits a signal (including a control signal, data, a process result, and so on; the same is true in the following explanation) to the other MCU 122, the CPU 123 of the MCU 121 writes the signal in the memory 127. Further, when the MCU 121 receives a signal from the other MCU 122, the CPU 123 of the MCU 121 reads the signal from the memory 127. The second embodiment is similar to the first embodiment except for the above-described configuration.

For example, a 16-bit signal cannot be sent at a time (i.e., in one sending action) in the serial communication in the first embodiment. In contrast to this, a 16-bit signal can be collectively written in the memory 127 at a time in the second embodiment. Therefore, compared to the first embodiment, cross-communication between the MCUs 121 and 122 can be performed at a higher speed in the second embodiment. Therefore, the second embodiment can contribute to the improvement in the real-time response property even further.

Note that it is preferred to determine which of the memories 127 of the MCUs 121 and 122 and which part of the memory area of that memory 127 are used for the signal writing/reading operation in advance.

The present invention made by the inventors has been explained above in a specific manner based on embodiments. However, the present invention is not limited to the above-described embodiments, and needless to say, various modifications can be made without departing from the spirit and scope of the present invention.

For example, in the above-described embodiments, the two RTOS accelerators 124 and the Ethernet accelerator 125 are newly formed as hardware (i.e., newly constructed in the form of hardware components). However, even when only one of them is formed as hardware, the embodiment can contribute to the improvement in the real-time response property. Therefore, the embodiment can be modified to a configuration in which only one of the two RTOS accelerators 124 and the Ethernet accelerator 125 is formed as hardware.

The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A safety monitoring device disposed between a network and a target device, comprising:
first and second microcomputers, wherein
each of the first and second microcomputers comprises:
a CPU; and
a first hardware device configured to perform a process for switching a task executed by the CPU and a process for starting the task.

2. The safety monitoring device according to claim 1, wherein
data input/output between the safety monitoring device and the target device is made redundant,
the first microcomputer receives/outputs one of the redundant data from/to the target device, and
the second microcomputer receives/outputs another of the redundant data from/to the target device.

3. The safety monitoring device according to claim 1, wherein each of the first and second microcomputers further comprises:
a memory; and
a second hardware device configured to perform a process for recording data transmitted/received between the safety monitoring device and the network in the memory.

4. The safety monitoring device according to claim 3, wherein the second hardware device further performs a process for detecting an error in data received from the network.

5. The safety monitoring device according to claim 4, wherein the second hardware device detects the error in the data received from the network by using a checksum.

6. The safety monitoring device according to claim 3, wherein
data is transmitted in a form of a frame on the network, and
the second hardware device further performs a process for extracting data from a frame received from the network and a process for storing data to be transmitted to the network in a frame.

7. The safety monitoring device according to claim 3, wherein
the memories of the first and second microcomputers are directly connected to each other, and
the CPU writes a signal to be transmitted to the other microcomputer in the memory and reads a signal to be received from the other microcomputer from the memory.

8. The safety monitoring device according to claim 7, wherein which of the memories of the first and second microcomputers and which part of a memory area thereof are used for a signal writing/reading operation are determined in advance.

9. A network system comprising:
a target device; and
a safety monitoring device disposed between a network and the target device, wherein
the safety monitoring device comprises first and second microcomputers, and
each of the first and second microcomputers comprises:
a CPU; and
a first hardware device configured to perform a process for switching a task executed by the CPU and a process for starting the task.

10. A safety monitoring method performed by a safety monitoring device disposed between a network and a target device, wherein
the safety monitoring device comprises first and second microcomputers, and
each of the first and second microcomputers performs, by using a first hardware device, a process for switching a task executed by a CPU and a process for starting the task.
